(19) United States
(12) Patent Application Publication
(10) Pub. No.: US 2005/0259669 A1
(43) Pub. Date: Nov. 24, 2005

(54) Media gateway device

(75) Inventor: Toshihisa Ozu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/988,598

(22) Filed: Nov. 16, 2004

(30) Foreign Application Priority Data
May 18, 2004 (JP) 2004-148006

(51) Int. Cl. H04L 12/56

(52) U.S. Cl. 370/401

(57) ABSTRACT

A gateway device is set to the doubled construction of the media gateway of the normal operation and the media gateway for redundancy. When a device failure is generated in the above media gateway of the normal operation, a signal path is controlled so as to be switched to the media gateway for redundancy by a switching unit. The IP address and the MAC address possessed in the above media gateway of the normal operation are transferred to the media gateway for redundancy simultaneously with the switching from the above media gateway of the normal operation to the media gateway for redundancy.

### BACKGROUND OF THE INVENTION

1. Field of the Invention

This invention relates to a media gateway device for connecting e.g., PSTN (Public Switched Telephone Network) to IP (Internet Protocol) networks, and particularly relates to a media gateway device having a redundant system.

2. Description of Related Art

It is known that one portion within the device is set to a redundant construction to prevent that a failure is generated in hardware of one portion within the device and communication is interrupted. In this construction, the device is switched to a redundant device by detecting the generation of the failure, etc., and the redundant device is used. For example, there is a structure for monitoring the abnormality of a communication path by arranging a switching device for switching a network on the network side mutually connecting routers (e.g., referring to Japanese Laid-opened Patent Publication JP-A-2002-84284). In this structure, the contents of path information arranged in the router and operating and un-operating modes of the router are conformed to each other by switching the operating and un-operating states of the above switching device and switching a default route to the router having no path control function when the failure is detected. However, the network system of the patent literature 1 doubles the entire network system. Therefore, a problem exists in that no failure generating portion can be specified.

On the other hand, in the gateway device for mutually connecting two doubled communication networks, a structure for setting this gateway device to the doubled construction of a main system and a standby system is known (e.g., referring to Japanese Laid-opened Patent Publication JP-A-2003-37636) In this structure, the gateway device is switched to the gateway device of the standby system by detecting the generation of the failure in the gateway device of the main system. However, when the two networks are the PSTN (public switched telephone network)-IP network, or the IP network-IP network, an IP address as a logic number for specifying a node in the network, and a MAC address as a hardware address given to each node are used. Therefore, it is not necessarily easy to take redundancy. This is because it is necessary to move the IP address and the MAC address possessed in the gateway device of the above main system to the gateway device of the standby system simultaneously with the switching when the gateway device of the above main system is switched to the gateway device of the standby system. However, in the above patent literature 2, there is no description as to what countermeasure is taken with respect to this problem.

### SUMMARY OF THE INVENTION

This invention is made to solve the above problems and a first object of this invention is to provide a media gateway device able to immediately start its operation by taking over the IP address and the MAC address possessed in the media gateway of the above normal operation in the media gateway for redundancy together with the switching from the media gateway of the above normal operation to the media gateway for redundancy.

A second object of this invention is to provide a media gateway device able to commonly use the media gateway for redundancy with respect to plural media gateways of the normal operation in the above media gateway device.

A third object of this invention is to provide a media gateway device for monitoring the failure situation of the device and switching the gateway by judging an important degree of the failure in the above media gateway device.

This invention resides in a media gateway device connected to an IP network on at least one side thereof, and characterized in that the gateway device is set to the doubled construction of a media gateway of a normal operation and a media gateway for redundancy, and has a switching unit for controlling a signal path so as to be switched to the media gateway for redundancy in generating a device failure in the media gateway of the normal operation, and at least one of an IP address and a MAC address possessed in the media gateway of the normal operation is transferred to the media gateway for redundancy simultaneously with the switching from the media gateway of the normal operation to the media gateway for redundancy.

In accordance with this invention, the media gateway for redundancy takes over the IP address or the MAC address of the media gateway of the normal operation and can immediately start its operation. Therefore, the media gateway for redundancy can be continuously operated without being conscious of the switching operation to the media gateway for redundancy in the media gateway of an opposite side or another connected device.

### BRIEF DESCRIPTION OF THE DRAWINGS

FIG. 1 is a schematic view of a media gateway system showing the basic construction of this invention.

FIG. 2 is a detailed block constructional view of the media gateway system into which a redundant construction in an embodiment mode 1 of this invention is assembled.

FIG. 3 is a view showing a constructional example of a media gateway system in an embodiment mode 2 of this invention.

FIG. 4 is a block diagram showing the function of the media gateway formed as a card.

FIG. 5 is a table showing the relation of a device failure example and a failure degree in an embodiment mode 3 of this invention.

FIG. 6 is a flow chart showing an important degree judging operation of the media gateway of the normal operation in an embodiment mode 3 of this invention.

FIG. 7 is a flowchart showing the important degree judging operation of a switching unit in the embodiment mode 3 of this invention.

### DESCRIPTION OF THE PREFERRED EMBODIMENTS

### Embodiment Mode 1

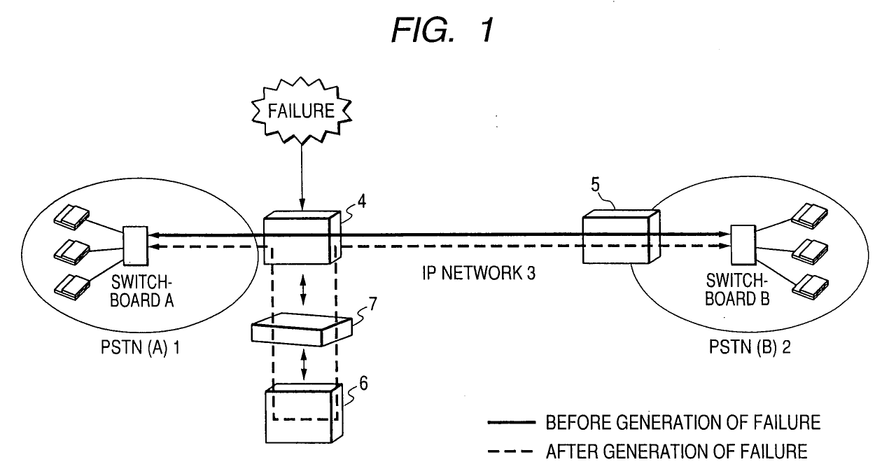

One embodiment mode of this invention will next be explained with reference to the drawings. FIG. 1 is a schematic view showing the basic construction of this invention, and shows an operating image of a media gateway system assembling a redundant construction thereinto. In this figure, reference numerals 1 and 2 designate PSTNs (public telephone exchanging circuit networks). The PSTNs 1 and 2 respectively have switchboards A and B for switching plural telephones. Reference numeral 3 designates an IP (Internet protocol) network. The media gateway system is set such that a media gateway 4 of the normal operation exists between the PSTN 1 and the IP network 3, and a media gateway 5 of an opposite station exists between the IP network 3 and the PSTN 2.

Further, a media gateway 6 for redundancy is inserted into the above media gateway 4 of the normal operation through a switching unit 7. Namely, when a failure (device alarm) is generated within the media gateway 4 of the normal operation, a signal path is switched to the media gateway 6 for redundancy by control of the switching unit 7. Thus, the media gateway 5 of the opposite station can be continuously operated without being conscious of the switching operation. In FIG. 1, a solid line shows a signal route before the failure is generated, and a dotted line shows a signal route after the failure is generated.

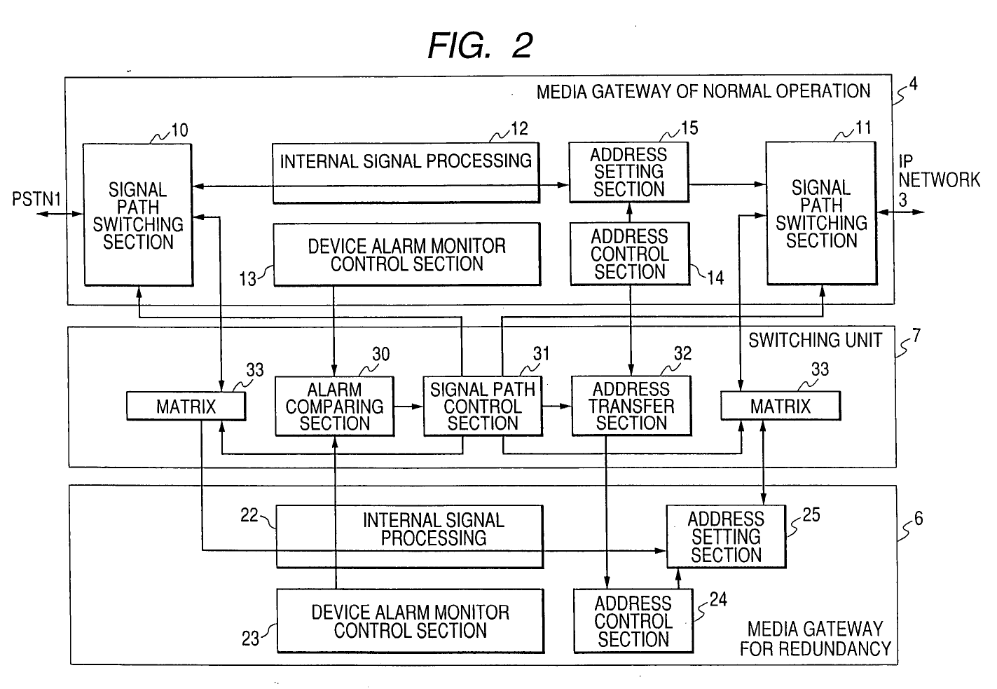

FIG. 2 shows a detailed block constructional view of the media gateway system into which a redundant construction in the embodiment mode 1 of the present invention is assembled. In this figure, the media gateway 4 of the normal operation and the media gateway 6 for redundancy approximately have the same circuit construction except that signal path switching sections 10, 11 are arranged in the media gateway 4 of the normal operation. Namely, internal signal processing circuits 12, 22, device alarm monitor control sections 13, 23, address control sections 14, 24 and address setting sections 15, 25 exist in both the media gateway 4 of the normal operation and the media gateway 6 for redundancy. The device alarm monitor control sections 13, 23 respectively monitor the existence of device alarms of their own devices at all times. When the device alarm is generated, each of the device alarm monitor control sections 13, 23 detects and notifies this generation to the switching unit 7.

Here, the generating case of the device alarm only in the media gateway 4 of the normal operation is supposed, and its operation will next be explained. When the device alarm is generated in the media gateway 4 of the normal operation, the device alarm monitor control section 13 detects this generation and notifies the alarm state to the switching unit 7. An alarm comparing section 30 is arranged within the switching unit 7. The alarm comparing section 30 compares the alarm states of the media gateway 4 of the normal operation and the media gateway 6 for redundancy. Here, since the device alarm is generated in only the media gateway 4 of the normal operation, information of the alarm comparing section 30 is notified to a signal path control section 31. This signal path control section 31 switches the signal path from the media gateway 4 of the normal operation to the media gateway 6 for redundancy by controlling the operations of the signal path switching sections 10, 11 of the media gateway 4 of the normal operation. Thereafter, the signal is inputted and outputted to the media gateway 6 for redundancy.

Next, an IP address and a MAC address outputted to the IP network at a redundant time will be explained. The address control sections 14, 24 are arranged in the media gateway 4 of the normal operation and the media gateway 6 for redundancy. The address control sections 14, 24 respectively notify the IP address and the MAC address to the address setting sections 15, 25, and its information is set to the IP address and the MAC address of a packet outputted from the device. Further, the media gateway 4 of the normal operation notifies the IP address and the MAC address of its own device to an address transfer section 32 of the switching unit 7 in advance. A method for periodically notifying these addresses every constant time is recommended in the notifying method.

The address transfer section 32 within the switching unit 7 possesses the IP address and the MAC address notified from the media gateway 4 of the normal operation as a database. When the above signal path control section 31 requests the switching of the signal path from the signal path switching sections 10, 11 of the media gateway 4 of the normal operation, the address transfer section 32 notifies the IP address and the MAC address of the media gateway 4 of the normal operation to the media gateway 6 for redundancy.

Thus, the media gateway 6 for redundancy can take over the IP address and the MAC address of the media gateway 4 of the normal operation, and can immediately start its operation. The media gateway 6 for redundancy can be continuously operated without being conscious of the switching to the media gateway for redundancy in the media gateway 5 of the opposite side or another connected device.

### Embodiment 2

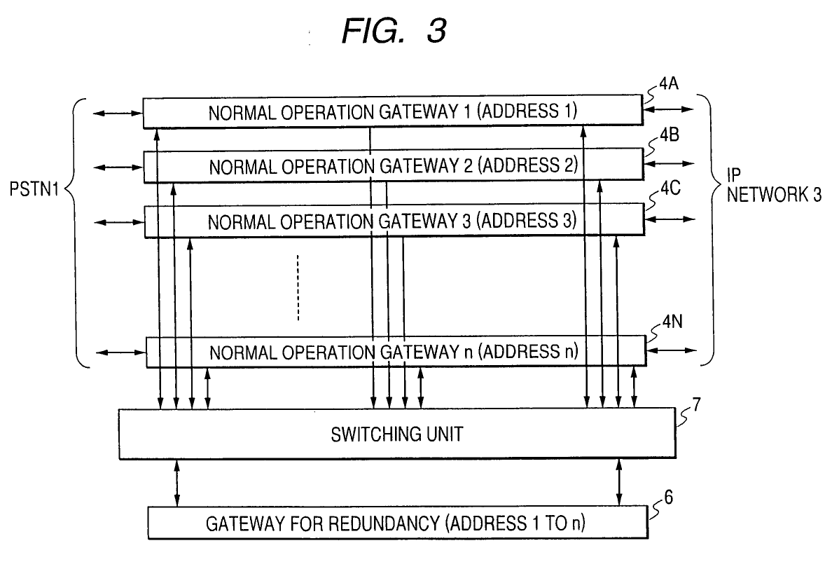

FIG. 3 is a view showing a constructional example of a media gateway system in an embodiment mode 2 of this invention. In the media gateway redundant system of the above embodiment mode 1, the assembling case of the 1+1 redundant construction having one media gateway of the redundant operation with respect to one media gateway of the normal operation is shown. However, in this embodiment mode, the assembling case of a so-called N+1 redundant construction having N media gateways of the normal operation and one media gateway of the redundant operation is shown, and the media gateway of the redundant operation is commonly used in the plural media gateways 4A to 4N of the normal operation. The media gateways 4A to 4N of the normal operation have the same circuit construction and are connected in parallel with each other with respect to the switching unit 7, and have addresses 1 to n different from each other.

In this figure, address control sections 14, 24,—within the N media gateways 4A to 4N of the normal operation respectively notify the IP address and the MAC address of its own device to the address transfer section 32 of the switching unit 7. The address transfer section 32 possesses the IP addresses and the MAC addresses of the N media gateways 4A to 4N of the normal operation in the database. When a device alarm is generated in one of the N media gateways 4A to 4N of the normal operation, the device alarm monitor control section 13 of this device detects this generation, and notifies its information to the signal path control section 31 of the switching unit 7. A matrix 33 for selectively connecting the N media gateways 4A to 4N of the normal operation and the switching unit 7 is inserted into the switching unit 7 (see FIG. 2).

As explained in the embodiment mode 1, the signal path control section 31 controls the operations of the signal path switching sections 10, 11 of this device, and switches the signal path from the media gateway 4 of the normal operation to the media gateway 6 for redundancy. Further, the signal path control section 31 notifies the IP address and MAC address information of this device to the media gateway 6 of the redundant operation. Thus, the media gateway of the redundant operation can be operated as the redundant operation of the media gateway of the normal operation.

In accordance with this embodiment mode 2, there are features in that the number of required devices is reduced in redundant formation and device introducing cost can be reduced.

### Embodiment Mode 3

In the above embodiment modes 1, 2, the switching unit 7 monitors the existence of the device alarm of the media gateway of the normal operation/the media gateway of the redundant operation, and makes the switching judgment. Accordingly, there was no distinction in the contents of the device alarm.

In this embodiment mode 3, an important degree is given to the contents of the above device alarm, and is set to a reference of the judgment. For example, when the device alarm of a light degree is generated in the media gateway of the redundant operation but the device alarm of a heavy degree is generated in the media gateway of the normal operation, the switching unit judges that the switching is valid, and can switch the signal path to the media gateway of the redundant operation.

Namely, in FIG. 2, the device alarm monitor control sections 13, 23 of the media gateway of the normal operation/the media gateway of the redundant operation detect the device alarm, and notifies its information to the alarm comparing section 30 of the switching unit 7. However, if the important degree is given to each device alarm, it is possible to judge whether the switching is valid or invalid in the alarm comparing section 30. For example, when the device alarm of a light degree is generated in the media gateway of the normal operation and the device alarm of a heavy degree is generated in the media gateway of the redundant operation, the alarm comparing section 30 judges that the switching is invalid. In contrast to this, when alarms reverse to the above alarms are generated, the alarm comparing section 30 judges that the switching is valid.

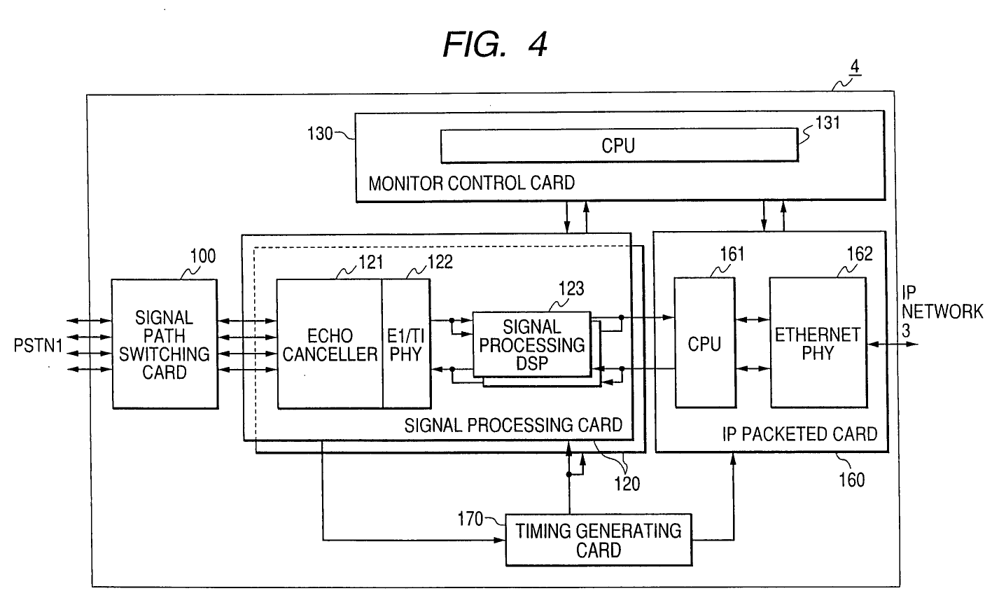

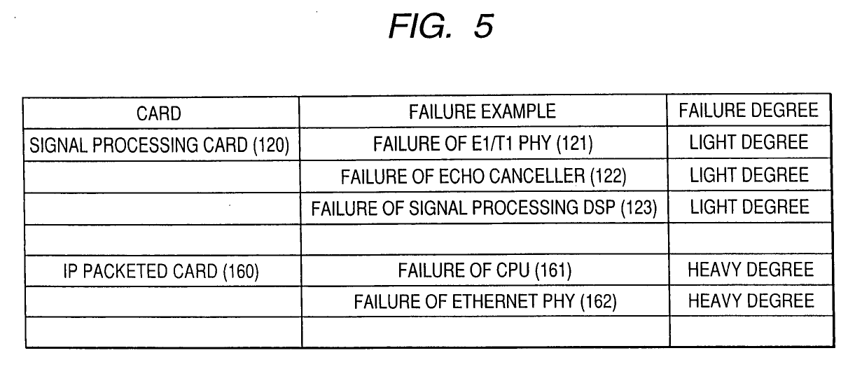

FIG. 4 is a block diagram showing the function of the media gateway formed as a card. FIG. 5 is a table showing the relation of a device failure example and a failure degree in an embodiment mode 3 of this invention.

In FIG. 4, reference numerals 100 and 120 respectively designate a signal path switching card, and a signal processing card constructed by an E1/T1 physical layer 121, an echo canceller 122 and a signal processing DSP (Digital Signal Processor) 123. Reference numerals 130 and 160 respectively designate a monitor control card having a CPU 131 for monitoring the states of each card and each module, and an IP packeted card constructed by a CPU 161 for assembling and decomposing an IP/UDP (Internet Protocol/User Datagram Protocol) packet and an Ethernet physical layer 162. Reference numeral 170 designates a timing generating card. In FIG. 5, the important degrees of failures are respectively prescribed with respect to failure examples of the respective modules of the signal processing card 120 and the IP packeted card 160. For example, the failure of each module within the signal processing card 120 is set to a light degree. In contrast to this, the failure of each module of the IP packeted card 160 is set to a heavy degree.

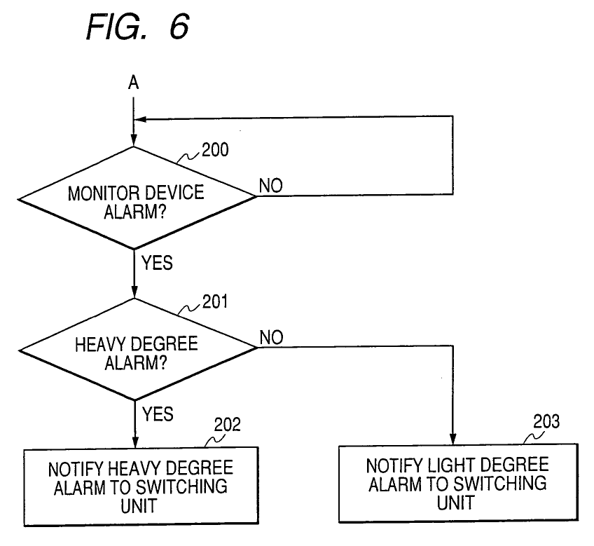

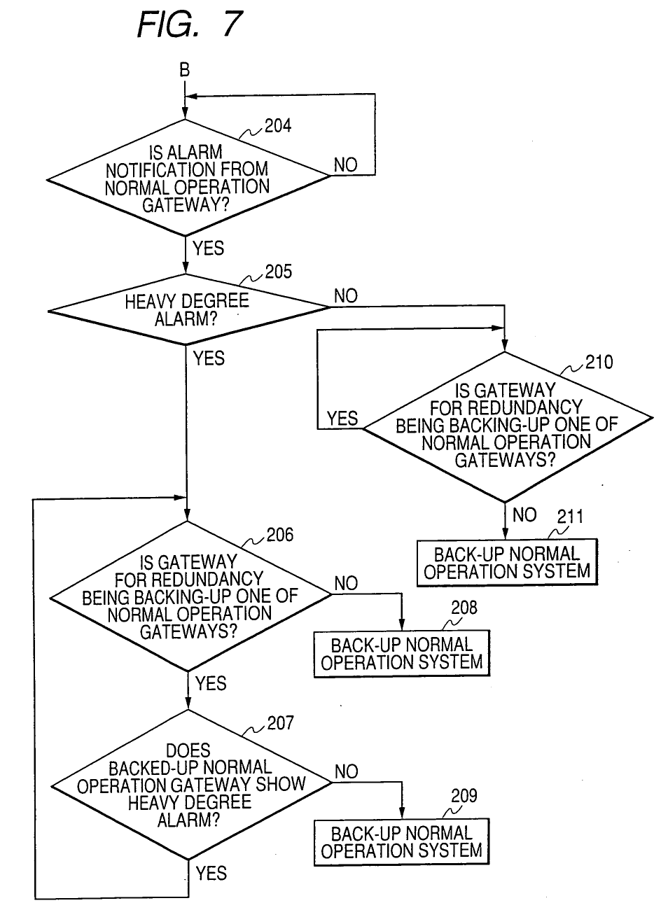

FIGS. 6 and 7 are flow charts in this embodiment mode showing the above important degree judging operation. FIG. 6 shows the judging operation in the media gateway 4 of the normal operation, and FIG. 7 shows the judging operation in the switching unit 7. When a device alarm A is detected in the CPU 131 of FIG. 4, this device alarm A is detected in a step 200. In a step 201, it is judged whether this device alarm A is a heavy degree alarm. As explained in FIG. 5, when the device alarm is a heavy degree alarm, the contents that the device alarm is a heavy degree alarm are notified to the switching unit 7. In contrast to this, when no device alarm is a heavy degree alarm, the contents that the device alarm is a light degree alarm are notified to the switching unit 7.

In FIG. 7, in a step 204, the switching unit 7 judges whether there is a notification B of the alarm from the media gateway 4 of the normal operation. Then, it proceeds to a judging step 205 as to whether this alarm is a heavy degree alarm. When it is a heavy degree step, it is judged in a step 206 whether the media gateway 6 of the redundant operation at that time is already being backing-up the media gateway of the normal operation. When the media gateway 6 of the redundant operation is already being backing-up the media gateway of the normal operation, it proceeds to a judging step 207 as to whether this back-up shows a heavy degree alarm. When this judging result is no, the back-up of this device is performed in a step 209. In contrast to this, when this judging result is yes, it is returned to the step 206 and the above steps are repeated until the back-up of the heavy degree alarm is released in the media gateway 6 of the redundant operation.

When no media gateway 6 of the redundant operation is being backing-up the media gateway of the normal operation in the step 206, the back-up of this device is performed in a step 208. Further, when no notification of the alarm from the media gateway 4 of the normal operation is the heavy degree alarm in the step 205, it is judged in a step 210 whether the media gateway 6 of the redundant operation at that time is being already backing-up the media gateway of the normal operation. When no media gateway 6 of the redundant operation is being backing-up the media gateway of the normal operation, the back-up of this device is performed in a step 211.

In accordance with this embodiment mode 3, since the switching operation is performed in consideration of the important degree of the alarm, there is a feature in that a finer redundant operation can be performed.

1. A media gateway device connected to an IP network on at least one side thereof, and characterized in that said gateway device is set to the doubled construction of a media gateway of a normal operation and a media gateway for redundancy, and has a switching unit for controlling a signal path so as to be switched to said media gateway for redundancy in generating a device failure in said media gateway of the normal operation, and at least one of an IP address and a MAC address possessed in said media gateway of the normal operation is transferred to the media gateway for redundancy in the switching from said media gateway of the normal operation to the media gateway for redundancy.

2. The media gateway device according to claim 1, wherein each of said media gateway of the normal operation and the media gateway for redundancy has a device alarm monitor control section for detecting each device failure and notifying its detecting information to said switching unit, and said switching unit has an alarm comparing section for comparing the device alarms from said each device alarm monitor control section, and a signal path control section for controlling the signal path so as to be switched from the media gateway of the normal operation to the media gateway for redundancy by a judging signal from said alarm comparing section.

3. The media gateway device according to claim 2, wherein said media gateway of the normal operation and the media gateway for redundancy have an address control section for setting the IP address or MAC address information of an outputted packet, and said switching unit has an address transfer section for holding the IP address or the MAC address notified from the media gateway of the normal operation, and notifying the IP address or the MAC address of the media gateway of the normal operation to the media gateway for redundancy when said signal path control section requests the switching of the signal path from the media gateway of the normal operation to the media gateway for redundancy.

4. The media gateway device according to claim 1, wherein the signal path is controlled so as to be switched to said media gateway for redundancy when plural media gateways of the normal operation are used in parallel with each other with respect to said one media gateway for redundancy and the device failure is generated in one of the media gateways of the normal operation.

5. The media gateway device according to claim 2, wherein said device alarm monitor control section gives an important degree to the contents of said device alarm, and sets the important degree to a reference of the failure judgment.
